(19) United States
(12) Patent Application Publication
(10) Pub. No.: US 2011/0234925 A1
(43) Pub. Date: Sep. 29, 2011

(54) Display device and electronic device

(75) Inventors: Satoshi Tatara, Kanagawa (JP); Katsuhide Uchino, Kanagawa (JP)

(73) Assignee: Sony Corporation, Tokyo (JP)

(21) Appl. No.: 12/929,814

(22) Filed: Feb. 17, 2011

(30) Foreign Application Priority Data
Mar. 29, 2010 (JP) 2010-075634

(51) Int. Cl. G09G 3/30; G09G 5/00; H04N 5/70

(52) U.S. Cl. 348/800; 345/212; 348/E05.135

(57) ABSTRACT

A display device includes: a display unit having a plurality of pixels each including a light emitting element, a drive transistor and a correction transistor, a scan line, a signal line, a power supply line and a gate line connected to the pixels; a scan line drive circuit applying a selection pulse to the scan line; and a signal line drive circuit writing a video signal to a pixel selected by the scan line drive circuit by applying a video signal voltage to the signal line. The drive transistor and the correction transistor are connected to each other in series on a path between the power supply line and the light emitting element in each of the pixels. Gate voltage for correction to be applied to the gate of the correction transistor via the gate line is set individually in each of unit regions in the display unit.

### BACKGROUND OF THE INVENTION

1. Field of the Invention

The present invention relates to a display device constructed by using light emitting elements such as organic EL (Electro Luminescence) elements and an electronic device having such a display device.

2. Description of the Related Art

In recent years, in the field of a flat panel display (FPD), attention to an organic EL display device is increasing. An organic EL display device is, different from a liquid crystal display (LCD), a device using light emitting elements and, therefore, does not require a backlight in principle. It is consequently advantageous more than an LCD from the viewpoint of thinness and higher luminance. In particular, in an organic EL display device of the active matrix type in which a switching element such as a TFT (Thin Film Transistor) is provided for each pixel, by making each pixel held lighted (lighted by making voltage retained in a capacitor), power consumption is kept low, and it is easier to realize a larger screen and higher precision. Consequently, the organic EL display device is being variously developed.

In such an organic EL display device of the active matrix type, from the viewpoint of assuring drive current, mainly, a TFT using a low-temperature polysilicon (p-Si) film is being studied and developed. The p-Si film is formed by irradiating an amorphous silicon (a-Si) film which is preliminarily formed with a laser beam from an excimer laser or the like to perform recrystallization (ELA method). Concretely, by performing the irradiation in a unit region while being sequentially shifted along a predetermined direction (horizontal or vertical direction) in a display face, recrystallization of the entire display face is carried out.

In the case of manufacturing an organic EL display device using a TFT having a p-Si film by the ELA method, however, a shortcoming occurs such that due to variations in shots of a laser beam, the values of mobility and threshold of a transistor for driving vary in the display face. When variations in the characteristic of the transistor occur in the display face, luminance variations (for example, stripe-shaped unevenness in the vertical or horizontal direction) are caused in the display face, and the display quality deteriorates.

To address the shortcoming, for example, Japanese Unexamined Patent Application Publication No. 2004-212684 discloses a method of reducing such characteristic variations by providing a plurality of drive transistors in pixels in parallel to divide light emission current and to average the characteristic variations of the drive transistors.

### SUMMARY OF THE INVENTION

In the method of Japanese Unexamined Patent Application Publication No. 2004-212684, however, in principle, the characteristic variations in the drive transistors are not adjusted individually (arbitrarily) in each of the regions in the display face, so that the effect of reducing the characteristic variations is insufficient.

In the existing method, it is difficult to reduce variations in the mobility and the threshold of the transistor for driving caused by a manufacture process or the like, so that a method for reducing the variations is in demand. The above-described shortcoming occurs not only in an organic EL display device but also in a display device using another kind of a light emitting element.

It is therefore desirable to provide a display device and an electronic device realizing improvement in display quality by suppressing luminance variations in a display face compared with an existing technique.

A first display device of an embodiment of the present invention includes: a display unit having a plurality of pixels, a scan line, a signal line, a power supply line and a gate line connected to each of the pixels, the plurality of pixels each including a light emitting element, a transistor for driving, and a transistor for correction; a scan line drive circuit which applies a selection pulse for sequentially selecting the plurality of pixels, to the scan line; and a signal line drive circuit which writes a video signal to a pixel selected by the scan line drive circuit by applying a video signal voltage to the signal line. In each pixel, the transistor for driving and the transistor for correction are connected to each other in series on a path between the power supply line and the light emitting element. The gate voltage for correction to be applied to the gate of the transistor for correction via the gate line is set individually in each of unit regions in the display unit.

A first electronic device of an embodiment of the invention includes the first display device of an embodiment of the invention.

In the first display device and the first electronic device of an embodiment of the invention, in each pixel, the transistor for driving and the transistor for correction are connected to each other in series on a path between the power supply line and the light emitting element, and the gate voltage for correction to be applied to the gate of the transistor for correction via the gate line is set individually in each of unit regions in the display unit. With the configuration, for example, even when the values of the mobility and the threshold of the transistor for driving vary among the unit regions, by individual setting of the gate voltage for correction, adjustment is performed arbitrarily so as to reduce variations in the values.

A second display device of an embodiment of the invention includes: a display unit having a plurality of pixels each including a light emitting element and a transistor for driving, and a scan line, a signal line, a power supply line, and a gate line connected to each of the pixels; a scan line drive circuit applying a selection pulse for sequentially selecting the plurality of pixels, to the scan line; and a signal line drive circuit writing a video signal to a pixel selected by the scan line drive circuit by applying a video signal voltage to the signal line. In each pixel, the transistor for driving is disposed on a path between the power supply line and the light emitting element. The gate voltage for correction to be applied to a back gate of the transistor for driving via the gate line is set individually in each of unit regions in the display unit.

A second electronic device of an embodiment of the invention has the second display device of an embodiment of the invention.

In the second display device and the second electronic device of an embodiment of the invention, in each pixel, the transistor for driving is disposed on a path between the power supply line and the light emitting element, and the gate voltage for correction to be applied to the back gate of the transistor for driving via the gate line is set individually in each of unit regions in the display unit. With the configuration, for example, even when the values of the mobility and the threshold of the transistor for driving vary among the unit regions, by individual setting of the gate voltage for correction, adjustment is performed arbitrarily so as to reduce variations in the values.

In the first display device and the first electronic device of an embodiment of the invention, in each pixel, the transistor for driving and the transistor for correction are connected to each other in series on a path between the power supply line and the light emitting element, and the gate voltage for correction to be applied to the gate of the transistor for correction via the gate line is set individually in each of unit regions in the display unit. Consequently, variations in the mobility and the threshold of the transistor for driving among the unit regions are reduced. Therefore, by reducing such variations caused by, for example, manufacture process, luminance variations in a display face are suppressed, and the display quality is improved.

In the second display device and the second electronic device of an embodiment of the invention, in each pixel, the transistor for driving is disposed on a path between the power supply line and the light emitting element, and the gate voltage for correction to be applied to the back gate of the transistor for driving via the gate line is set individually in each of unit regions in the display unit. Consequently, variations in the mobility and the threshold of the transistor for driving among the unit regions are reduced. Therefore, by reducing such variations caused by, for example, manufacture process, luminance variations in a display face are suppressed, and the display quality is improved.

Other and further objects, features and advantages of the invention will appear more fully from the following description.

### BRIEF DESCRIPTION OF THE DRAWINGS

FIG. 1 is a block diagram illustrating an example of a display device of a first embodiment of the present invention.

FIG. 2 is a circuit diagram illustrating a configuration example of a pixel shown in FIG. 1.

FIG. 3 is a cross section illustrating a configuration example of each transistor shown in FIG. 2.

FIG. 4 is a schematic diagram for explaining an example of a laser annealing process performed at the time of forming each transistor illustrated in FIG. 3.

FIGS. 5A and 5B are characteristic diagrams for explaining a characteristic example in a light emitting operation in a drive transistor and a correction transistor illustrated in FIG. 2.

FIG. 6 is a circuit diagram expressing a configuration example in a pixel in a display device of comparative example 1.

FIGS. 7A and 7B are diagrams for explaining luminance unevenness in a display face in the display device of the comparative example 1.

FIG. 8 is a circuit diagram expressing a configuration example in a pixel in a display device of comparative example 2.

FIGS. 9A and 9B are diagrams for explaining an action of reducing luminance unevenness in a display face in the display device according to the first embodiment.

FIGS. 10A and 10B are circuit diagrams for explaining the action of reducing luminance unevenness in the display face in the display device according to the first embodiment.

FIG. 11 is a circuit diagram illustrating a configuration example in a pixel in a display device according to a second embodiment.

FIGS. 12A and 12B are circuit diagrams for explaining an action of reducing luminance unevenness in a display face in the display device according to the second embodiment.

FIG. 13 is a circuit diagram illustrating a configuration example in a pixel in a display device according to a third embodiment.

FIG. 14 is a characteristic diagram for explaining an action of reducing luminance unevenness in a display face in the display device according to the third embodiment.

FIGS. 15A and 15B are schematic diagrams for explaining a laser annealing process in a display device according to a modification of the invention.

FIG. 16 is a plan view expressing a schematic configuration of a module including the display device of the embodiment.

FIG. 17 is a perspective view illustrating the appearance of application example 1 of the display device of the embodiment.

FIG. 18A is a perspective view illustrating the appearance on the surface side of application example 2, and FIG. 18B is a perspective view illustrating the appearance on the back side.

FIG. 19 is a perspective view illustrating the appearance of application example 3.

FIG. 20 is a perspective view illustrating the appearance of application example 4.

FIG. 21A is a front view in an open state of application example 5, FIG. 21B is a side vide, FIG. 21C is a front view in a close state, FIG. 21D is a left side view, FIG. 21E is a right side view, FIG. 21F is a top view, and FIG. 21G is a bottom view.

### DETAILED DESCRIPTION OF THE PREFERRED EMBODIMENTS

Embodiments of the present invention will be described in detail hereinbelow with reference to the drawings. The description will be given in the following order.

1. First embodiment (example of a pixel circuit in which a correction transistor is disposed between a power supply line and a drive transistor)
2. Second embodiment (example of a pixel circuit in which a drive transistor is disposed between a power supply line and a correction transistor)
3. Third embodiment (example of applying gate voltage for correction is applied to the back gate of a drive transistor)
4. Modification (modification on the laser annealing direction)
5. Modules and Application Examples (examples of application to electronic devices)

### First Embodiment

### Configuration of Display Device

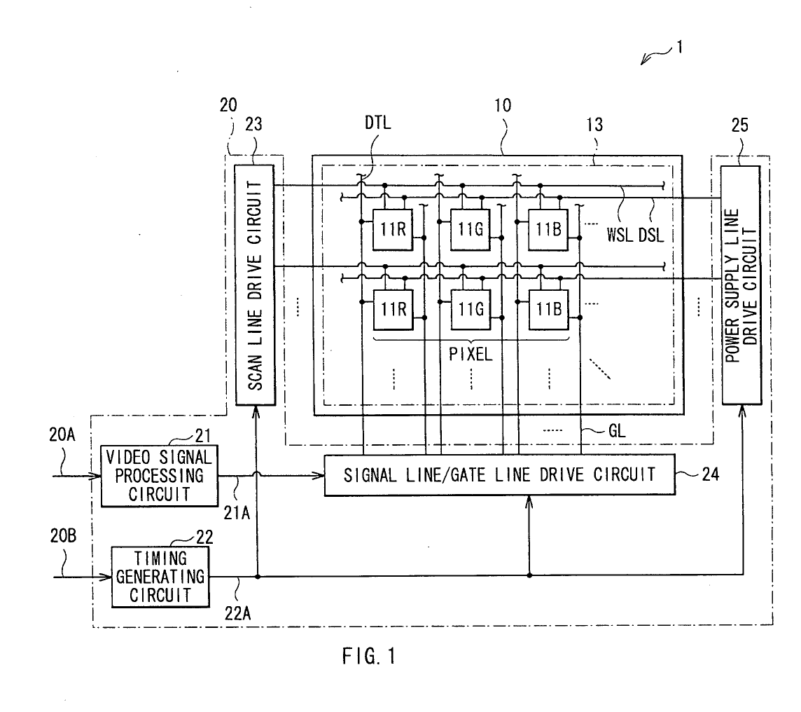

FIG. 1 is a block diagram showing a schematic configuration of a display device 1 according to a first embodiment of the present invention. The display device 1 has a display panel 10 (display unit) and a drive circuit

Display Panel 10

The display unit 10 has a pixel array 13 in which a plurality of pixels 11R, 11G and 11B are arranged in a matrix, and displays an image on the basis of a video signal 20A and a synchronizing signal 20B input from the outside by active matrix drive. The pixels 11R, 11G, and 11B correspond to pixels which emit light of three primary colors of red (R), blue (B), and green (G), respectively.

The pixel array 13 has a plurality of scan lines WSL disposed in rows, a plurality of signal lines DTL disposed in columns, a plurality of power supply lines DSL disposed in rows along the scan lines WSL, and a plurality of gate lines GL disposed in columns along the signal lines DTL. One end of each of the scan lines WSL, the signal lines DTL, the power supply lines DSL, and gate lines GL is connected to the drive circuit 20 which will be described later. The pixels 11R, 11G, and 11B are disposed in rows and columns (in matrix) at intersections of the scan lines WSL and the power supply lines DSL and the signal lines DTL and the gate lines GL.

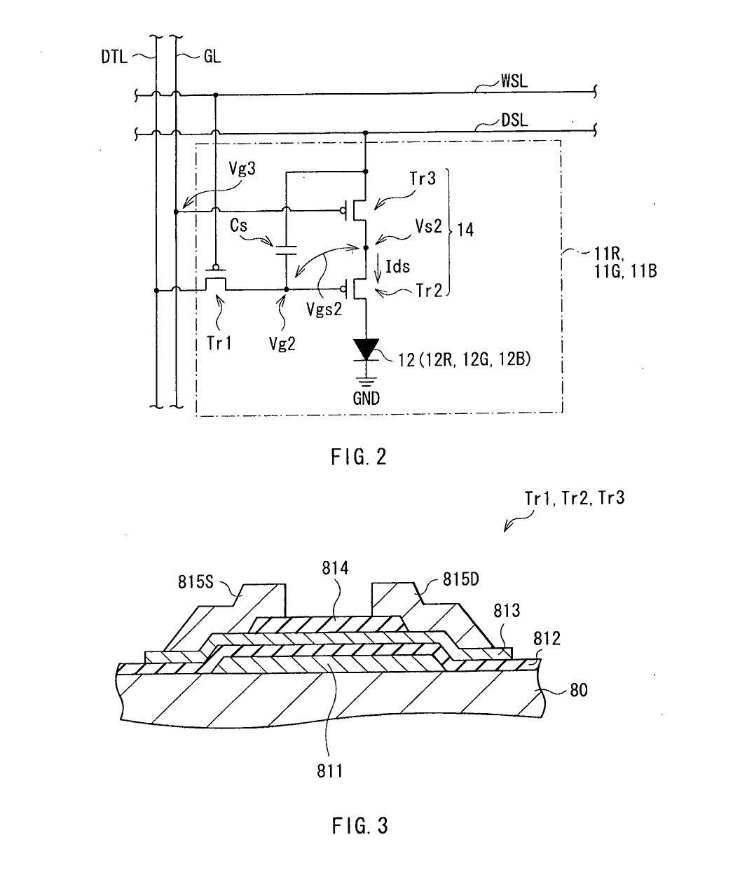

FIG. 2 illustrates an example of the internal configuration (circuit configuration) of the pixels 11R, 11G, and 11B. In each of the pixels 11R, 11G, and 11B, an organic EL element 12 (light emitting element) and a pixel circuit 14 are provided. The organic EL elements 12R, 12G and 12B illustrated in the diagram correspond to organic EL elements which emit light of the primary colors of red (R), blue (B), and green (G), respectively. In the following, the organic EL elements 12R, 12G, and 12B will be collectively called the organic EL element 12.

The pixel circuit 14 is constructed by a write (sampling) transistor Tr1 (first transistor) for writing (sampling), a drive transistor Tr2 (second transistor), a correction transistor Tr3 (third transistor), and a retention capacitive element Cs. That is, the pixel circuit 14 has a circuit configuration of so-called “3Tr1C”. Each of the write transistor Tr1, the drive transistor Tr2, and the correction transistor Tr3 is a p-channel MOS (Metal Oxide Semiconductor)-type TFT. The kind of the TFT is not limited and may be of, for example, an inverted staggered structure (so-called bottom gate type) or a staggered structure (so-called top gate type).

In the pixel circuit 14, the gate of the write transistor Tr1 is connected to the scan line WSL, the source thereof is connected to the signal line DTL, and the drain thereof is connected to the gate of the drive transistor Tr2 and one end of the retention capacitive element Cs. The gate of the correction transistor Tr3 is connected to the gate line GL, the source thereof is connected to the power supply line DSL and the other end of the retention capacitive element Cs, and the drain thereof is connected to the source of the drive transistor Tr2. The drain of the drive transistor Tr2 is connected to the anode of the organic EL element 12, and the cathode of the organic EL element 12 is set to a fixed potential (in this case, the ground (earth potential)). That is, in the pixel circuit 14, the drive transistor Tr2 and the correction transistor Tr3 are connected to each other in series on the path between the power supply line DSL and the organic EL element 12. Concretely, the correction transistor Tr3 is disposed between the power supply line DSL and the drive transistor Tr2.

FIG. 3 illustrates an example of a sectional configuration of each of the transistors (the write transistor Tr1, the drive transistor Tr2, and the correction transistor Tr3) in the pixel circuit 14.

In each of the transistors Tr1, Tr2, and Tr3, on a substrate 80 as the entire display panel 10, a gate electrode 811, a gate insulating film 812, a p-Si (polycrystal (poly) silicon) film 813, an insulating film 814 as an etching stopper layer, and a source electrode 815S and a drain electrode 815D are formed in this order. The substrate 80 is, for example, a Si substrate or glass substrate. The gate electrode 811 is made of a metal material such as molybdenum (Mo), and each of the gate insulating film 812 and the insulating film 814 is made of an insulating material such as silicon oxide (SiO) or silicon nitride (SiN). Each of the source electrode 815S and the drain electrode 815D is made of a metal material such as aluminum (Al).

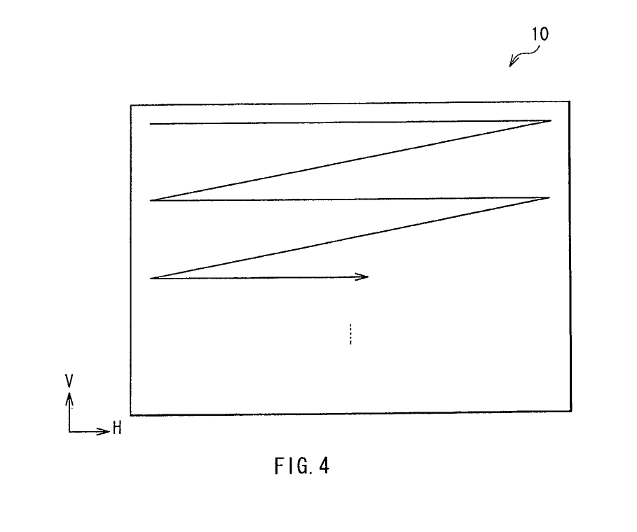

The p-Si film 813 is formed by performing recrystallization (using the ELA) by irradiating an amorphous silicon (a-Si) film which is preliminarily formed with a laser beam from an excimer laser or the like. Concretely, for example, as schematically illustrated in FIG. 4, irradiation in a unit region is performed while being slightly shifted in a predetermined direction (in this case, the horizontal directions (H directions)) in the display panel 10 (display face), thereby performing the recrystallization in the entire display panel 10 (pixel array 13).

Drive Circuit 20

The drive circuit 20 illustrated in FIG. 1 drives each of the pixels 11R, 11G, and 11B in the pixel array 13 to emit light (display driving). Concretely, while sequentially selecting the plurality of pixels 11R, 11G, and 11B in the pixel array 13, by writing a video signal voltage based on the video signal 20A to the selected pixels 11R, 11G, and 11B, the display driving is performed on the plurality of pixels 11R, 11G, and 11B.

The drive circuit 20 has a video signal processing circuit 21, a timing generating circuit 22, a scan line drive circuit 23, a signal line/gate line drive circuit 24, and a power supply line drive circuit 25.

The video signal processing circuit 21 performs predetermined correction on the digital video signal 20A input from the outside and outputs the corrected video signal 21A to the signal line/gate line drive circuit 24. The predetermined correction is, for example, gamma correction, overdrive correction, or the like.

The timing generating circuit 22 generates a control signal 22A on the basis of the synchronizing signal 20B input from the outside and outputs the control signal 22A, thereby controlling the display operation. Concretely, it controls so that the scan line drive circuit 23, the signal line/gate line drive circuit 24, and the power supply line drive circuit 25 perform the display operation interlockingly.

The scan line drive circuit 23 sequentially applies a selection pulse to the plurality of scan lines WSL according to (synchronously with) the control signal 22A to sequentially select the plurality of pixels 11R, 11G, and 11B. Concretely, by selectively outputting a voltage Von to be applied to set the write transistor Tr1 into the on state and a voltage Voff to be applied to set the write transistor Tr1 into the off state, the above-described selection pulse is generated. The voltage Von has a value (constant value) equal to or larger than the on-state voltage of the write transistor Tr1, and the voltage Voff has a value (constant value) lower than the on-state voltage of the write transistor Tr1.

The signal line/gate line drive circuit 24 has a signal line drive circuit and a gate line drive circuit (not shown).

The signal line drive circuit generates an analog video signal corresponding to the video signal 21A input from the video signal processing circuit 21 according to (synchronously with) the control signal 22A, and applies the video signal to the signal lines DTL. Concretely, by individually applying an analog video signal voltage of a color based on the video signal 21A to any of the signal lines DTL, the video signal is written in the pixel 11R, 11G, or 11B selected by the scan line drive circuit 23.

The gate line drive circuit applies a correction gate voltage Vg3 which will be described later to each of the gate lines GL according to (synchronously with) the control signal 22A. As the details will be described later, the correction gate voltage Vg3 is set to each of unit regions (for example, a low-voltage setting region 10gL or a high-voltage setting region 10gH) in the display panel 10 (the pixel array 13).

The power supply line drive circuit 25 sequentially applies a control pulse to the plurality of power supply lines DSL according to (synchronously with) the control signal 22A, thereby controlling the light emitting operation and the light-off operation on each of the organic EL elements 12. Concretely, by selectively outputting a voltage VH applied when current Ids is passed to the drive transistor Tr2 and a voltage VL applied when the current Ids is not passed to the drive transistor Tr2, the above-described control pulse is generated. The voltage VL is set so as to have a voltage value (constant value) lower than a voltage value (Vthel+Vcat) obtained by adding a threshold voltage Vthel and the cathode voltage Vcat in the organic EL element 12. On the other hand, the voltage VH is set to have a voltage value (constant value) equal to or larger than the voltage value (Vthel+Vcat).

Action and Effect of Display device

### Display Operation

In the display device 1, as shown in FIGS. 1 and 2, the drive circuit 20 performs display driving based on the video signal 20A and the synchronizing signal 20B on the pixels 11R, 11G, and 11B in the display panel 10 (the pixel array 13). The drive current is passed to the organic EL element 12 in a light emitting part in each of the pixels 11R, 11B, and 11G, holes and electrons are recombined, and light emission occurs. As a result, in the display panel 10, an image is displayed on the basis of the video signal 20A.

Concretely, with reference to FIG. 2, in the light emitting part 111, a video signal writing operation (display operation) is performed as follows. First, in a period in which the voltage on the signal line DTL is a video signal voltage and the voltage on the power supply line DSL is the voltage VH, the scan line drive circuit 23 increases the voltage on the scan line WSL from the voltage Voff to the voltage Von. It makes the write transistor Tr1 enters the on state, so that the gate potential Vg2 of the drive transistor Tr2 rises to a video signal voltage corresponding to the voltage on the signal line DTL at this time. As a result, the video signal voltage is written and retained in the retention capacitive element Cs. In such a display operation, the predetermined gate potential Vg3 (in this case, gate correction voltage Vg3L or Vg3H) is constantly applied to the gate line GL, and the correction transistor Tr3 is in the on state.

At this stage, the anode voltage of the organic EL element 12 is still smaller than a voltage value (Vel+Vca) obtained by adding threshold voltage Vel and cathode voltage Vca (=ground potential) in the organic EL element 12, and the organic EL element 12 is in a cutoff state. In other words, at this stage, no current flows between the anode and the cathode of the organic EL element 12 (the organic EL element 12 does not emit light). Therefore, the current Ids supplied from the drive transistor Tr2 flows to an element capacitor (not shown) existing in parallel between the anode and the cathode of the organic EL element 12, and the element capacitor is charge.

Next, during a period in which the voltage of the signal line DTL is held at the video signal voltage and the voltage of the power supply line DSL is held at the voltage VH, the scan line drive circuit 23 decreases the voltage of the scan line WSL from the voltage Von to the voltage Voff. It makes the write transistor Tr1 enter the off state, so that the gate of the drive transistor Tr2 enters a floating state. In a state where a gate-source voltage Vgs2 of the drive transistor Tr2 is held constant, the current Ids flows between the drain and source of the drive transistor Tr2. As a result, the source potential Vs2 of the drive transistor Tr2 rises, and the gate potential Vg2 of the drive transistor Tr2 also rises interlockingly by capacitive coupling via the retention capacitive element Cs. Accordingly, the anode voltage of the organic EL element 12 becomes larger than a voltage value (Vel+Vca) obtained by adding the threshold voltage Vel and the cathode voltage Vca in the organic EL element 12. Therefore, the current Ids according to the video signal voltage retained in the retention capacitive element Cs, that is, the gate-source voltage Vgs2 in the drive transistor Tr2 flows between the anode and the cathode of the organic EL element 12, and the organic EL element 12 emits light with desired luminance.

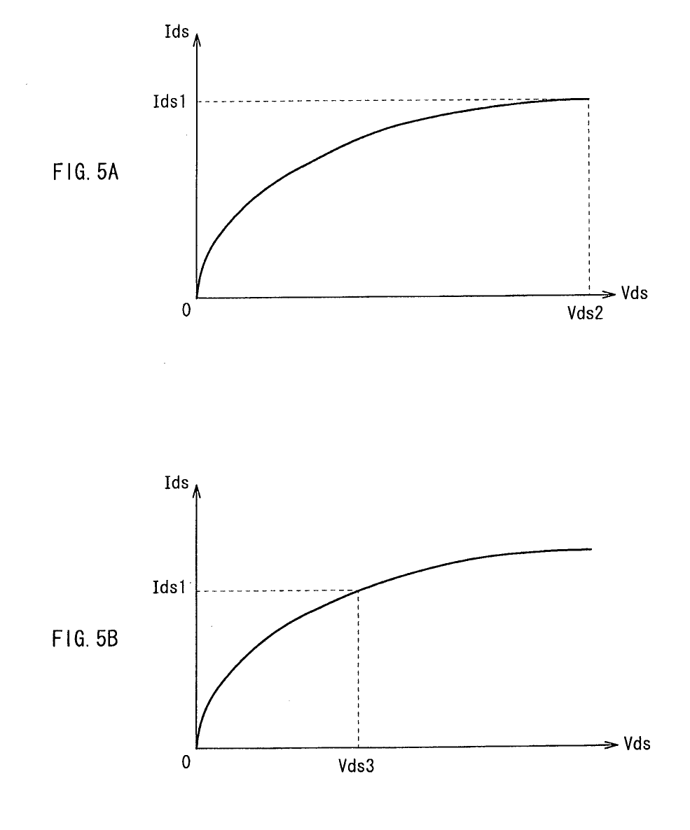

In the light emitting operation of the organic EL element 12, for example, as illustrated in FIG. 5A, the drive transistor Tr2 operates in a saturation region. On the other hand, for example, as illustrated in FIG. 5B, the correction transistor Tr3 operates in a linear region. In the example, in the drive transistor Tr2, when the source-drain voltage Vds is equal to Vds2, the current (light emission current) Ids flows between the source and the drain. On the other hand, in the correction transistor Tr3, when the source-drain voltage Vds is equal to Vds3 (<Vds2), the current (light emission current) Ids flows between the source and the drain.

Subsequently, after lapse of a predetermined period, the drive circuit 20 finishes the light emission period of the organic EL element 12. Concretely, the power supply line drive circuit 25 decreases the voltage on the power supply line DSL from the voltage VH to the voltage VL. The source potential Vs2 of the drive transistor Tr2 decreases. The anode voltage of the organic EL element 12 becomes smaller than the voltage value (Vel+Vca) obtained by adding the threshold voltage Vel and the cathode voltage Vca in the organic EL element 12, and the current Ids does not flow between the anode and the cathode. As a result, the organic EL element 12 quenches (shifts to a quench period).

After that, the drive circuit 20 performs the display operation so that the light emitting operation and the quenching operation described above are repeated on the frame period (1 vertical (1V) period) unit basis. The drive circuit 20 also performs, for example, a scan in the row direction with the control pulse to be applied to the power supply line DSL and the selection pulse to be applied to the scan line WSL every 1 horizontal period (1H period). In such a manner, the display operation in the display device 1 (the display drive by the drive circuit 20) is performed.

Operation of Characteristic Part

Next, the operation in the characteristic part in the display device 1 of the embodiment will be described in detail in comparison with comparative examples (comparative examples 1 and 2).

### Comparative Example 1

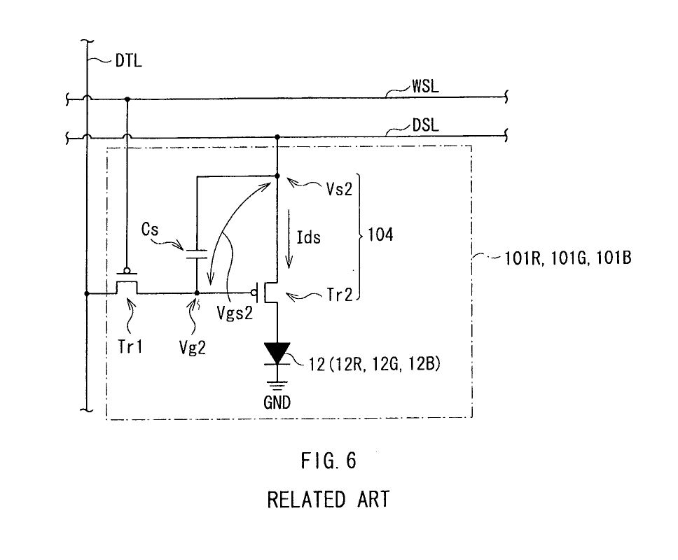

FIG. 6 illustrates the internal configuration (circuit configuration) of the pixels 101R, 101B, and 101G in a display device according to comparative example 1. Each of the pixels 101R, 101G, and 101B of the comparative example 1 has a pixel circuit 104 in place of the pixel circuit 14 of the embodiment illustrated in FIG. 2. Concretely, the pixel circuit 104 has a circuit configuration obtained by not including the correction transistor Tr3 in the pixel circuit 14. It causes the following disadvantage in the display operation of the comparative example 1.

First, as described above with reference to FIGS. 3 and 4, the p-Si film 813 in the transistors Tr1 and Tr2 is formed by recrystallization by irradiating an a-Si film with a laser beam from an excimer laser or the like (ELA method). Concretely, for example, by performing irradiation in a unit region while being shifted sequentially in a predetermined direction (in this case, the H directions) in the display panel 10, the recrystallization in the entire display panel 10 is performed.

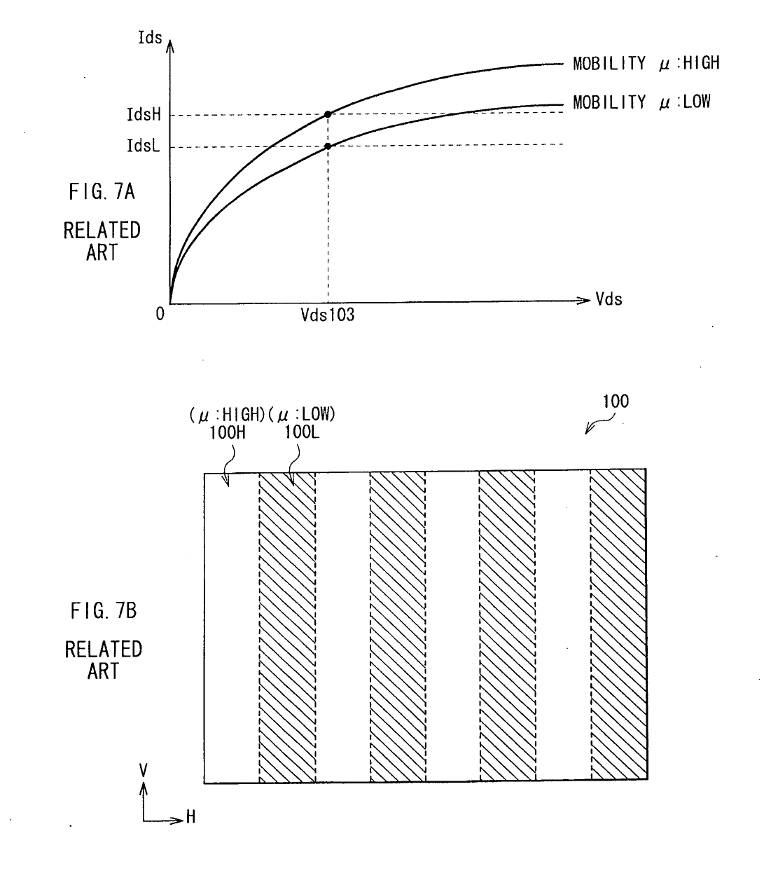

However, in the case of manufacturing an organic EL display device (the display device according to the comparative example 1) using the drive transistor Tr2 having the p-Si film 813 using the ELA method, the following disadvantage occurs. Due to variations in shots of the laser beam, for example, as illustrated in FIG. 7A, the mobility μ and the value of the threshold voltage Vth of the drive transistor Tr2 vary in the display face. Concretely, in the example, in the pixels 101R, 101G, and 101B whose mobility μ is relatively low when the source-drain voltage Vds is equal to Vds103 in the drive transistor Tr2, the current (light emission current) Ids flowing between the source and the drain is equal to IdsL. On the other hand, in the pixels 101R, 101G, and 101B whose mobility μ is relatively high regardless of the fact that the source-drain voltage Vds is also equal to Vds103, the current Ids flowing between the source and the drain in the drive transistor Tr2 is equal to IdsH (>IdsL).

When variations occur in the characteristic (in this case, mobility μ) of the drive transistor Tr2 in such a display face, variations in luminance (in this case, for example, stripe-shaped unevenness in the H direction as illustrated in FIG. 7B) in the display face are caused, thereby deteriorating the display quality. Concretely, in the example illustrated in FIG. 7B, in the display panel 100, a pixel region of relatively high mobility μ (high-luminance region 100H) and a pixel region of relatively low mobility μ (low-luminance region 100L) are alternately formed in the H direction, and horizontal stripe unevenness occurs.

### Comparative Example 2

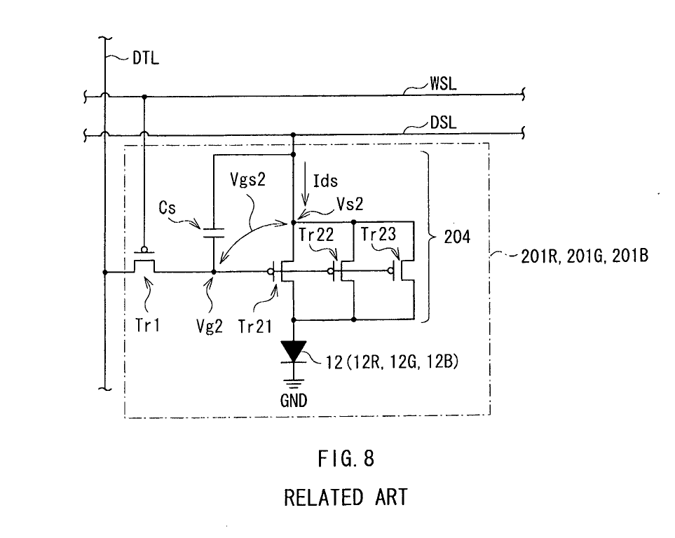

FIG. 8 illustrates the internal configuration (circuit configuration) of pixels 201R, 201B, and 201G in a display device according to comparative example 2. Each of the pixels 201R, 201G, and 201B of the comparative example 2 has a pixel circuit 204 in place of the pixel circuit 14 of the embodiment illustrated in FIG. 2. Concretely, the pixel circuit 204 has a circuit configuration obtained by not including the correction transistor Tr3 in the pixel circuit 14 but by including a plurality of (three in this case) drive transistors Tr21, Tr22, and Tr23 which are connected to one another in parallel in place of the single drive transistor Tr2. The gates of the drive transistors Tr21, Tr22, and Tr23 are commonly connected to one another (the drain of the write transistor Tr1 and one end of the retention capacitive element Cs are commonly connected).

In the comparative example 2 having the pixel circuit 204, in the display operation, the current (light emission current) Ids flows so as to be split to the three drive transistors Tr21, Tr22, and Tr23. Consequently, characteristic variations in the drive transistors Tr21, Tr22, and Tr23 are averaged. Such characteristic variations are reduced as compared with the characteristic variations in the comparative example 1. However, in the pixel circuit 204 of the comparative example 2, in principle, the characteristic variations in the drive transistors Tr21, Tr22, and Tr23 are not adjustable individually (arbitrarily) in each of the regions in the display face (for example, in each of the high-luminance region 100H and the low-luminance region 100L illustrated in FIG. 7B). Consequently, in the comparative example 2, an effect of reducing such characteristic variations is insufficient.

Characteristic Action of First Embodiment

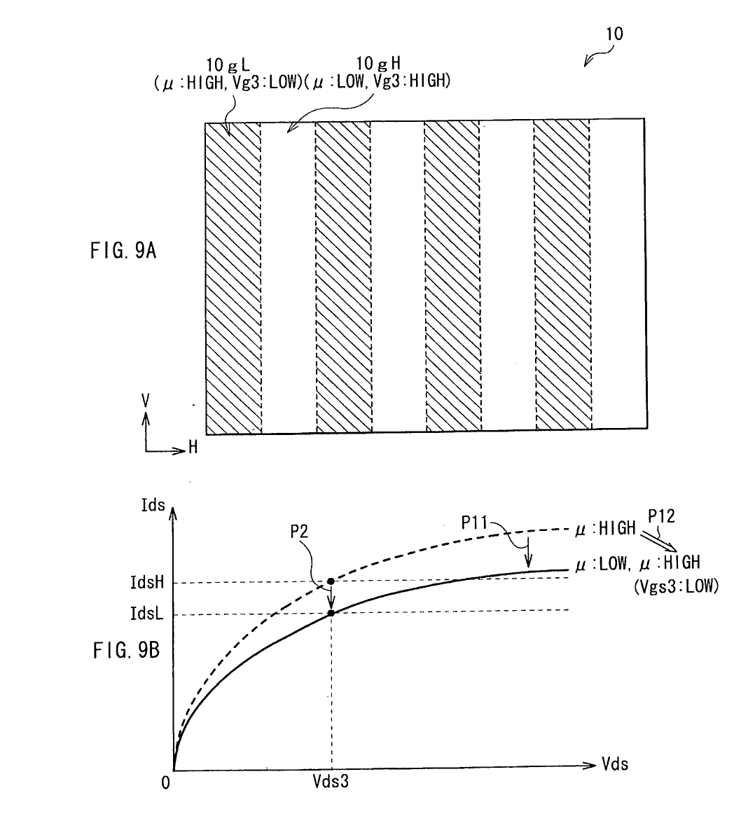

In contrast, in the display device 1 of the embodiment, as illustrated in FIGS. 1 and 2, in the pixel circuit 14 of each of the pixels 11R, 11G, and 11B, the drive transistor Tr2 and the correction transistor Tr3 are connected to each other in series on the path between the power supply line DSL and the organic EL element 12. Concretely, the correction transistor Tr3 is disposed between the power supply line DSL and the drive transistor Tr2. For example, as illustrated in FIG. 9A, the correction gate voltage Vg3 to be applied to the gate of the correction transistor Tr3 via the gate line GL is set individually by the unit region in the display panel 10.

Concretely, for example, as illustrated in FIGS. 9A and 9B, in unit regions in which the mobility μ of each of the transistors Tr1 to Tr3 is relatively high, the correction gate voltage Vg3 is set to be relatively low (low-voltage setting regions 10gL). On the other hand, in unit regions in which the mobility μ of each of the transistors Tr1 to Tr3 is relatively low, the correction gate voltage Vg3 is set to be relatively high (high-voltage setting regions 10gH). In other words, the regions (the low-voltage setting region 10gL and the high-voltage setting region 10gH) in the display panel 10 are set on the basis of the distribution of variations in the light emission luminance in the display panel 10. In the example, the display panel 10, like the display panel 100 illustrated in FIG. 7B, employs the unit region setting corresponding to the case where the pixel region of the relatively high mobility μ and the pixel region of the relatively low mobility μ are formed alternately in the H direction. The mobility μ of each of the transistors Tr1 to Tr3 in the unit regions is obtained by measuring the light emission luminance in the organic EL element 12 (for example, a measurement conducted by using camera and light emission current), for example, before shipment of the product of the display device 1.

Specifically, the example illustrated in FIG. 9B will be described as follows. In the example, first, when the source-drain voltage Vds in the correction transistor Tr3 is equal to Vds3, the current (light emission current) Ids in the pixels 11R, 11G, and 11B of relatively low mobility p is equal to IdsL. On the other hand, in the pixels 11R, 11G, and 11B of relatively high mobility μ, when the source-drain voltage Vds is equal to Vds3, the current Ids is equal to IdsH (>IdsL). In the embodiment, for example, as shown by arrows P11 and P12 in the diagram, in the pixels 11R, 11G, and 11B of relatively high mobility μ, the value of the correction gate voltage Vgs3 is set so that the values of the current Ids coincide in the pixels 11R, 11G, and 11B of relatively low mobility p (refer to the arrow P2 in the diagram). In other words, the value of the correction gate voltage Vg3 is set so that the characteristic of the correction transistor Tr3 in the pixel of the relatively high mobility μ and that in the pixel of the relatively low mobility μ coincide.

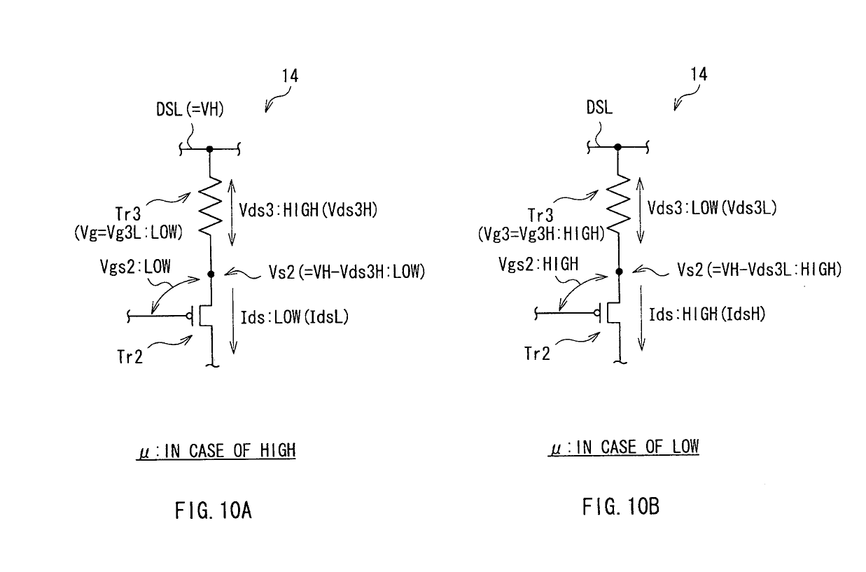

Therefore, for example, as illustrated in FIG. 10A, when the mobility μ is relatively high, the following occurs. Since the correction gate voltage Vg3 to be applied to the gate of the correction transistor Tr3 is set relatively low (for example, Vg3L), the voltage Vds3 across the source and drain of the correction transistor Tr3 becomes relatively high (for example, Vds3H). Consequently, the source potential Vs3 (=VH−Vds3H) of the drive transistor Tr3 becomes relatively low. Accordingly, the gate-source voltage Vgs2 becomes relatively low, so that the light emission current Ids becomes relatively low (for example, IdsL). In this diagram and other diagrams, to show that the correction transistor Tr3 operates in the linear region, the correction transistor Tr3 is illustrated by the symbol of resistance.

On the other hand, as illustrated in FIG. 10B, when the mobility is relatively low, the following occurs. Since the correction gate voltage Vg3 to be applied to the gate of the correction transistor Tr3 is set relatively high (for example, Vg3H (>Vds3L)), the voltage Vds3 across the source and drain of the correction transistor Tr3 becomes relatively low (for example, Vds3L (<Vds3H)). Consequently, the source potential Vs3 (=VH−Vds3H) of the drive transistor Tr3 becomes relatively high. Accordingly, the gate-source voltage Vgs2 becomes relatively high, so that the light emission current Ids becomes relatively high (for example, IdsH (>IdsL)).

Even if the values of the mobility μ and the threshold voltage Vth of the drive transistor Tr2 vary among, for example, unit regions in the embodiment, the adjustment is performed arbitrarily by individual setting of the correction gate voltage Vg3 so as to reduce the variations in the values.

As described above, in the embodiment, in each of the pixels 11R, 11G, and 11B, the drive transistor Tr2 and the correction transistor Tr3 are disposed so as to be connected to each other in series on the path between the power supply line DSL and the organic EL element 12, and the correction gate voltage Vg3 to be applied to the gate of the correction transistor Tr3 via the gate line GL is set individually in each of the unit regions (the low-voltage setting region 10gL and the high-voltage setting region 10gH) in the display panel 10. Consequently, variations in the mobility μ and the threshold voltage Vth of the drive transistor Tr2 in each of the unit regions are reduced. Therefore, for example, by reducing such variations caused by manufacturing process, variations in luminance (such as horizontal stripe-shaped unevenness) in the display panel 10 are suppressed, and the display quality is improved.

Subsequently, other embodiments (second and third embodiments) of the present invention will be described. In the following, the same reference numerals are designated to the same components as those of the first embodiment and their description will not be repeated.

### Second Embodiment

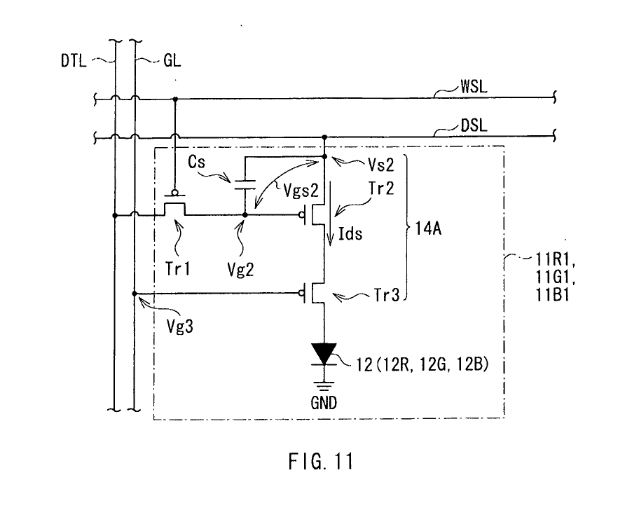

FIG. 11 illustrates the internal configuration (circuit configuration) of pixels 11R1, 11G1, and 11B1 in a display device according to a second embodiment. The pixels 11R1, 11G1, and 11B1 are similar to the pixels 11R, 11G, and 11B in the first embodiment except that a pixel circuit 14A is provided in place of the pixel circuit 14. The pixel circuit 14A is similar to the pixel circuit 14 except that the drive transistor Tr2 and the correction transistor Tr3 are disposed in an opposite manner, that is, the drive transistor Tr2 is disposed between the power supply line DSL and the correction transistor Tr3. Since the other configuration is similar to that of the display device 1 of the first embodiment, its description will not be repeated.

Concretely, in the pixel circuit 14A of the embodiment, the gate of the write transistor Tr1 is connected to the scan line WSL, the source thereof is connected to the signal line DTL, and the drain thereof is connected to the gate of the drive transistor Tr2 and one end of the retention capacitive element Cs. The gate of the correction transistor Tr3 is connected to the gate line GL. The source of the drive transistor Tr2 is connected to the power supply line DSL and the other end of the retention capacitive element Cs, and the drain thereof is connected to the source of the correction transistor Tr3. The drain of the correction transistor Tr3 is connected to the anode of the organic EL element 12, and the cathode of the organic EL element 12 is set to a fixed potential (in this case, the ground (earth potential)).

In other words, also in the pixel circuit 14A, in a manner similar to the first embodiment, the drive transistor Tr2 and the correction transistor Tr3 are connected to each other in series on the path between the power supply line DSL and the organic EL element 12. Concretely, in the embodiment, the drive transistor Tr2 is disposed between the power supply line DSL and the correction transistor Tr3. In a manner similar to the first embodiment, the correction gate voltage Vg3 to be applied to the gate of the correction transistor Tr3 via the gate line GL is set in each of the unit regions in the display panel 10.

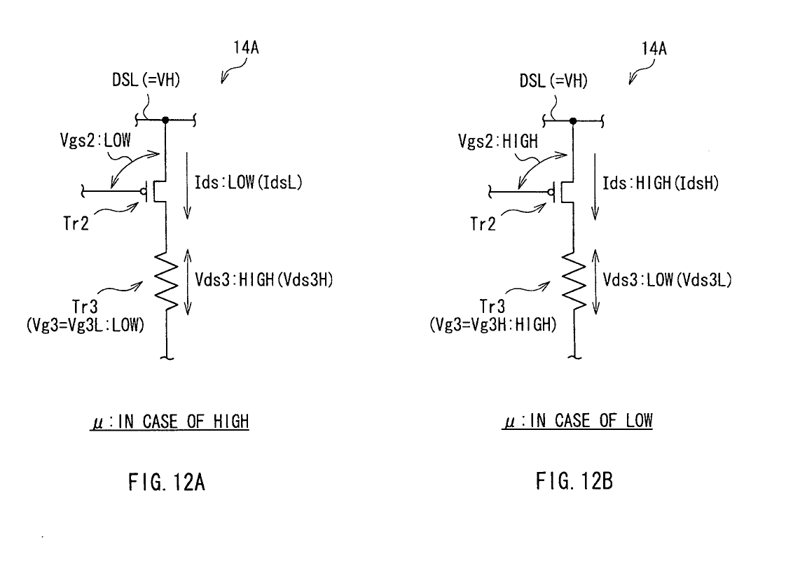

In the embodiment, for example, as illustrated in FIG. 12A, when the mobility μ is relatively high, the following occurs. First, the correction gate voltage Vg3 to be applied to the gate of the correction transistor Tr3 is set relatively low (for example, Vg3L), so that the correction gate voltage Vds3 between the source and the drain in the correction transistor Tr3 becomes relatively high (for example, Vds3H). Consequently, the gate-source voltage Vgs2 of the drive transistor Tr3 becomes relatively low, and the light emission current Ids becomes relatively low (for example, IdsL).

On the other hand, as illustrated in FIG. 12B, in the case where the mobility μ is relatively low, the following occurs. First, the correction gate voltage Vg3 to be applied to the gate of the correction transistor Tr3 is set relatively high (for example, Vg3H (>Vds3L), so that the voltage Vds3 between the source and the drain in the correction transistor Tr3 becomes relatively low (for example, Vds3L (<Vds3H)). Consequently, the gate-source voltage Vgs2 of the drive transistor Tr3 becomes relatively high, and the light emission current Ids becomes relatively high (for example, IdsH (>IdsL)).

As described above, the embodiment also produces effects similar to those of the first embodiment. That is, by reducing variations in the mobility μ and the threshold voltage Vth of the drive transistor Tr2 in each unit region caused by the manufacture process, the luminance variations in the display panel 10 are suppressed, and the display quality is improved.

### Third Embodiment

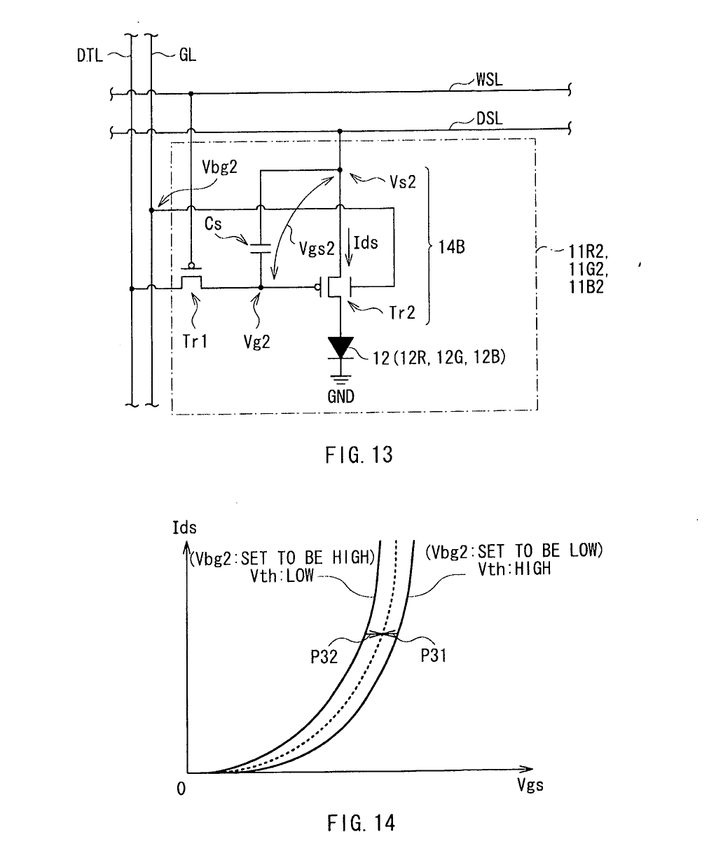

FIG. 13 illustrates the internal configuration (circuit configuration) of pixels 11R2, 11G2, and 11B2 in a display device according to a third embodiment. The pixels 11R2, 11G2, and 11B2 are similar to the pixels 11R, 11G, and 11B in the first embodiment except that a pixel circuit 14B is provided in place of the pixel circuit 14. The pixel circuit 14B is similar to the pixel circuit 14 except that the correction transistor Tr3 is not provided and the gate line GL is connected to the back gate of the drive transistor Tr2. That is, in the embodiment, the pixel circuit 14B has the circuit configuration of so-called “2Tr1C”, and the back gate potential Vbg2 of the drive transistor Tr2 is set to the correction gate voltage described above. A method of the embodiment to be described below is a method particularly effective to the case when only the threshold voltage Vth varies. Since the other configuration is similar to that of the display device 1 of the first embodiment, its description will not be repeated.

Concretely, in the pixel circuit 14B of the embodiment, the gate of the write transistor Tr1 is connected to the scan line WSL, the source thereof is connected to the signal line DTL, and the drain thereof is connected to the gate of the drive transistor Tr2 and one end of the retention capacitive element Cs. The source of the drive transistor Tr2 is connected to the power supply line DSL and the other end of the retention capacitive element Cs, the drain thereof is connected to the anode of the organic EL element 12, and the back gate is connected to the gate line GL. The cathode of the organic EL element 12 is set to a fixed potential (in this case, the ground (ground potential)). In other words, in the pixel circuit 14B, the drive transistor Tr2 is disposed on the path between the power supply line DSL and the organic EL element 12.

In the pixel circuit 14B, the drive transistor Tr2 is disposed on the path between the power supply line DSL and the organic EL element 12. The correction gate voltage Vg3 (=Vbg2) to be applied to the back gate of the drive transistor Tr2 via the gate line GL is set in each of the unit regions in the display panel 10.

Concretely, for example, as illustrated in FIG. 14, in the pixels 11R2, 11G2, and 11B2 having relatively high threshold voltage Vth, the following occurs. That is, the correction gate voltage Vg3 (=Vbg2) to be applied to the back gate of the drive transistor Tr2 is set relatively low, so that the light emission current Ids becomes relatively high (see the arrow P31 in the diagram). On the other hand, in the pixels 11R2, 11G2, and 11B2 having relatively low threshold voltage Vth, the following occurs. That is, the correction gate voltage Vg3 (=Vbg2) to be applied to the back gate of the drive transistor Tr2 is set relatively high, so that the light emission current Ids becomes relatively low (see the arrow P32 in the diagram).

Consequently, also in the embodiment, even when the values of the mobility μ and the threshold voltage Vth in the drive transistor Tr2 vary among, for example, unit regions, adjustment is arbitrarily performed so as to reduce the variations by individual setting of the correction gate voltage Vg3 (=Vbg2).

As described above, in the embodiment, the drive transistor Tr2 is disposed on the path between the power supply line DSL and the organic EL element 12 in each of the pixels 11R2, 11G2, and 11B2, and the correction gate voltage Vg3 (=Vbg2) to be applied to the back gate of the drive transistor Tr2 via the gate line GL is set individually in each of the unit regions in the display panel 10, so that variations in the mobility μ and the threshold voltage Vth of the drive transistor Tr2 in each unit region are reduced. Therefore, by reducing the variations caused by the manufacture process, the luminance variations in the display panel 10 are suppressed, and the display quality is improved.

The pixel circuit 14B of the embodiment does not have the correction transistor Tr3 (a configuration similar to the existing circuit of “2Tr1C”) different from the pixel circuits 14 and 14A of the first and second embodiments. Consequently, the above-described effects are obtained without increasing the number of elements.

### Modifications

Subsequently, a modification common to the first to third embodiments will be described. The same reference numerals are designated to the same components as those of the first embodiment and the like, and their description will not be repeated.

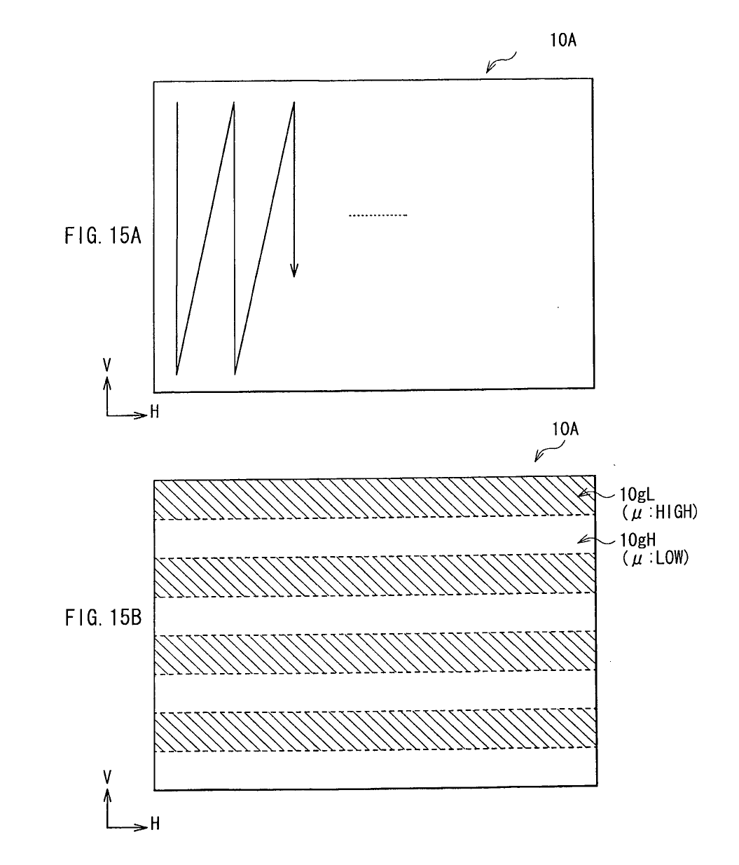

FIG. 15A schematically shows the irradiation directions at the time of forming the p-Si film 813 by the ELA (performing recrystallization) in the display panel (the display panel 10A) according to the modification. In the display panel 10A, different from the first to third embodiments, recrystallization in the entire display panel 10A is carried out by performing irradiation along the vertical (V) direction while being shifted sequentially.

Therefore, the modification employs, for example, as illustrated in FIG. 15B, the unit region setting corresponding to the case where the pixel region of the relative high mobility μ (low-voltage setting region 10gL) and the pixel region of the relatively low mobility μA (high-voltage setting region 10gH) are formed alternately in the V direction in the display panel 10A.

As in the modification, even in the case of setting the irradiation direction at the time of forming the p-Si film 813 by the ELA method (performing recrystallization) to another direction different from those in the first to third embodiments, by applying the methods of the first to third embodiments, similar effects are obtained.

### Modules and Application Examples

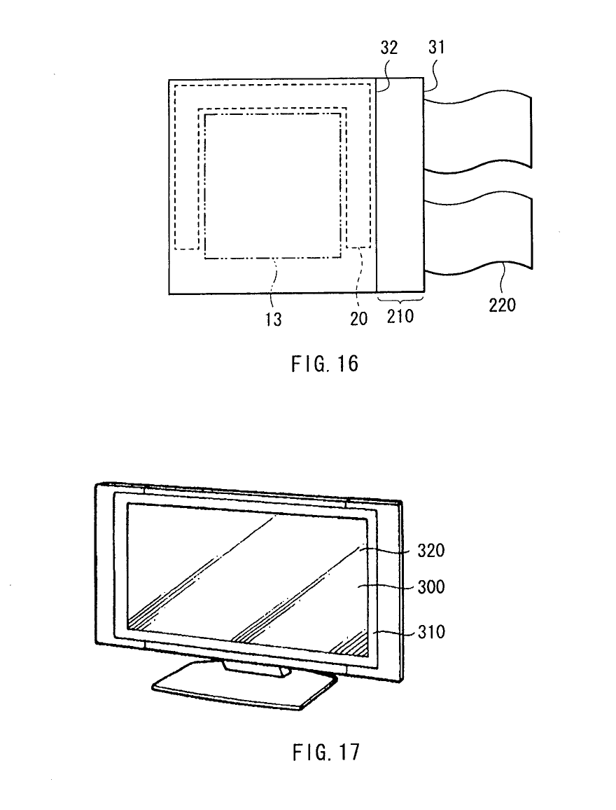

Referring now to FIGS. 16 to 21, application examples of the display device mentioned in the first to third embodiments and the modification will be described below. The display device of the embodiments and the like is applicable to an electronic device in all of fields such as a television apparatus, a digital camera, a notebook-sized personal computer, a portable terminal device such as a cellular phone, a video camera, or the like. In other words, the display device is applicable to electronic devices in all of fields, which displays a video signal input from the outside or a video signal generated on the inside as an image or a video image.

Module

The display device is incorporated, for example, as a module as shown in FIG. 16, in various electronic devices such as application examples 1 to 5 which will be described later. The module is obtained by, for example, providing a region 210 exposed from a substrate 32 for sealing in one side of a substrate 31 and forming external connection terminals (not shown) by extending wires of the drive circuit 20 in the exposed region 210. The external connection terminals may be provided with flexible printed circuits (FPCs) 220 for inputting/outputting signals.

### Application Example 1

FIG. 17 illustrates the appearance of a television apparatus to which the display device is applied. The television apparatus has, for example, a video display screen unit 300 including a front panel 310 and a filter glass 320. The video display screen unit 300 is constructed by the display device

### Application Example 2

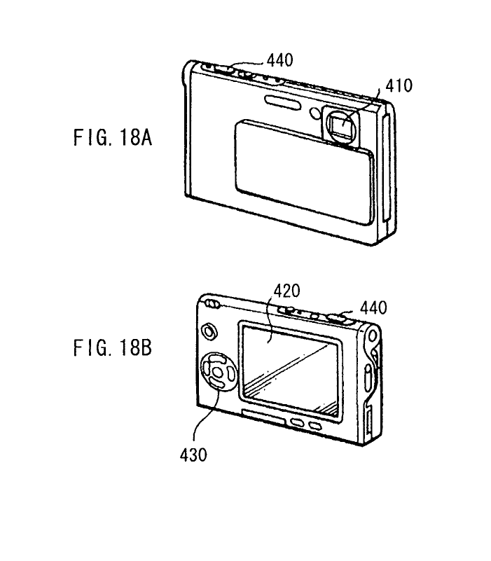

FIGS. 18A and 18B illustrate the appearance of a digital camera to which the display device is applied. The digital camera has, for example, a light emitting unit 410 for flash, a display unit 420, a menu switch 430, and a shutter button 440. The display unit 420 is constructed by the display device.

### Application Example 3

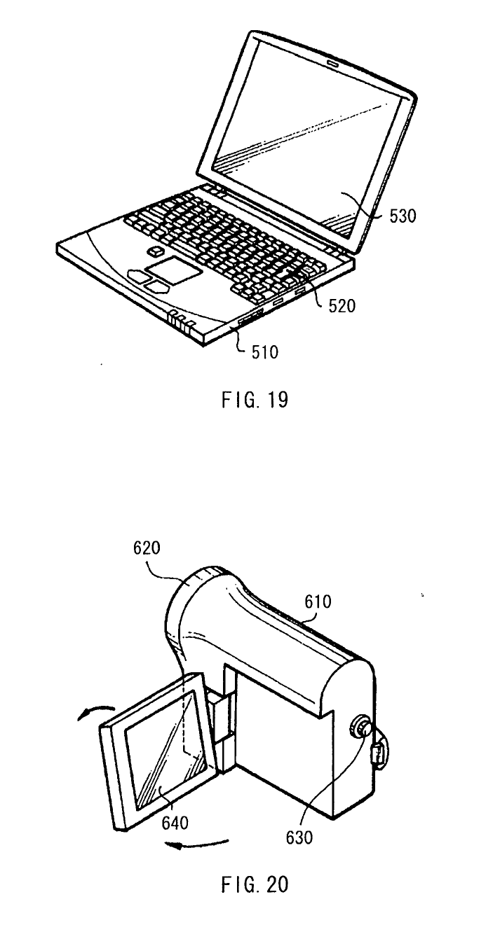

FIG. 19 illustrates the appearance of a notebook-sized personal computer to which the display device is applied. The notebook-sized personal computer has, for example, a body 510, a keyboard 520 for operation of inputting characters and the like, and a display unit 530 for displaying an image. The display unit 530 is constructed by the display device.

### Application Example 4

FIG. 20 illustrates the appearance of a video camera to which the display device is applied. The video camera has, for example, a body 610, a lens 620 for capturing a subject, provided in the front-side face of the body 610, a shooting start/stop switch 630, and a display unit 640. The display unit 640 is constructed by the display device.

### Application Example 5

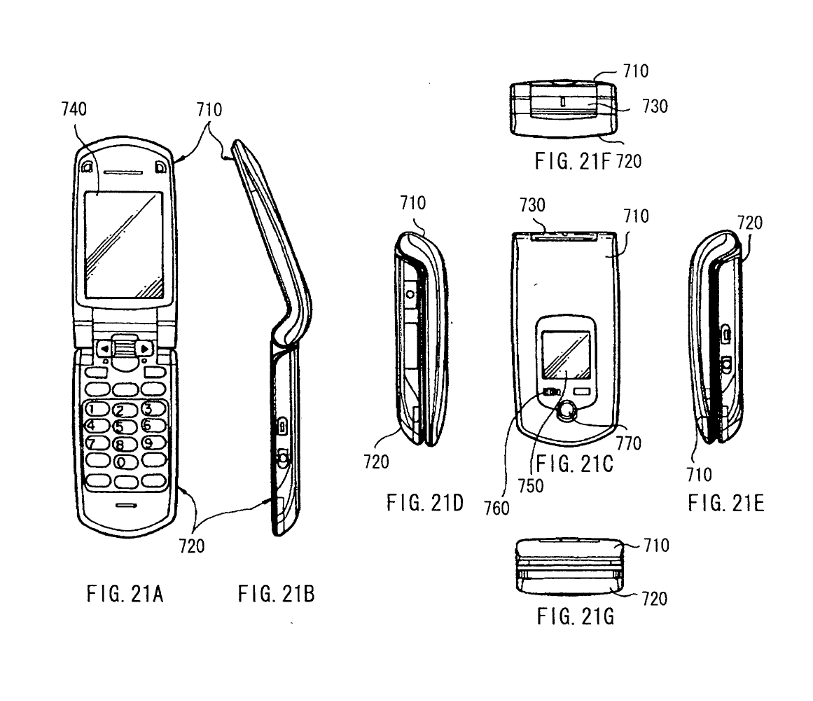

FIGS. 21A to 21G illustrate the appearance of a cellular phone to which the display device is applied. The cellular phone is constructed by, for example, coupling an upper casing 710 and a lower casing 720 by a coupling part (hinge) 730 and has a display 740, a sub-display 750, a picture light 760, and a camera 770. The display 740 or the sub-display 750 is constructed by the display device.

### Other Modifications

Although the present invention has been described above by the embodiments, the modification, and the application examples, the present invention is not limited to the embodiments and the like but may be variously modified.

For example, in the foregoing embodiments and the like, the case where the display device is of the active matrix type has been described. However, the configuration of the pixel circuit for the active matrix driving is not limited to that described in the foregoing embodiments and the like. Concretely, for example, as necessary, a capacitive element, a transistor, and the like may be added or replaced. In this case, according to a change in the pixel circuit, a necessary drive circuit may be provided in addition to the scan line drive circuit, the power supply line drive circuit, and the signal line drive circuit.

Although the case that the driving operations of the scan line drive circuit, the power supply line drive circuit, and the signal line drive circuit are controlled by the timing generating circuit has been described in the foregoing embodiments and the like, another circuit may control the driving operations. The scan line drive circuit, the power supply line drive circuit, and the signal line drive circuit may be controlled by hardware (circuit) or software (program).

Although the case where the transistors in the pixel circuit are p-channel transistors (TFTs of a p-channel MOS type) has been described in the foregoing embodiments and the like, the invention is not limited to the case. Specifically, each of the transistors may be an n-channel transistor (TFT of the n-channel MOS type).

The present application contains subject matter related to that disclosed in Japanese Priority Patent Application JP 2010-075634 filed in the Japanese Patent Office on Mar. 29, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit having a plurality of pixels, a scan line, a signal line, a power supply line and a gate line connected to each of the pixels, the plurality of pixels each including a light emitting element, a transistor for driving, and a transistor for correction;
a scan line drive circuit applying a selection pulse for sequentially selecting the plurality of pixels, to the scan line; and
a signal line drive circuit writing a video signal to a pixel selected by the scan line drive circuit by applying a video signal voltage to the signal line,
wherein the transistor for driving and the transistor for correction are connected to each other in series on a path between the power supply line and the light emitting element in each of the pixels, and
gate voltage for correction to be applied to the gate of the transistor for correction via the gate line is set individually in each of unit regions in the display unit.

2. The display device according to claim 1, wherein at the time of light emitting operation of the light emitting element, the transistor for driving operates in a saturated region, whereas the transistor for correction operates in a linear region.

3. The display device according to claim 2, wherein in a unit region in which mobility of each transistor is relatively high, the gate voltage for correction is set to be relatively low and,
in a unit region in which mobility of each transistor is relatively low, the gate voltage for correction is set to be relatively high.

4. The display device according to claim 3, wherein the mobility of each transistor in each unit region is obtained by measuring light emission luminance of the light emitting element.

5. The display device according to claim 4, wherein each of the unit regions is set on the basis of a distribution of variations in the light emission luminance in the display unit.

6. The display device according to claim 1, wherein the transistor for correction is disposed between the power supply line and the transistor for driving, in each of pixels.

7. The display device according to claim 6,
wherein each pixel includes an organic electroluminescence element as the light emitting element, a first transistor as a transistor for writing, a second transistor as the transistor for driving, a third transistor as the transistor for correction, and a retention capacitive element,
the gate of the first transistor is connected to the scan line,
one of a drain and a source in the first transistor is connected to the signal line, and the other is connected to the gate of the second transistor and one end of the retention capacitive element,
the gate of the third transistor is connected to the gate line,
one of a drain and a source in the third transistor is connected to the power supply line and the other end of the retention capacitive element, and the other is connected to one of a drain and a source in the second transistor,
the other one of the drain and the source in the second transistor is connected to an anode of the organic electroluminescence element, and
a cathode of the organic electroluminescence element is set to a fixed potential.

8. The display device according to claim 1, wherein the transistor for driving is disposed between the power supply line and the transistor for correction in each pixel.

9. The display device according to claim 8,
wherein each pixel includes an organic electroluminescence element as the light emitting element, a first transistor as a transistor for writing, a second transistor as the transistor for driving, a third transistor as the transistor for correction, and a retention capacitive element,
the gate of the first transistor is connected to the scan line,
one of a drain and a source in the first transistor is connected to the signal line, and the other is connected to the gate of the second transistor and one end of the retention capacitive element,
the gate of the third transistor is connected to the gate line,
one of a drain and a source in the second transistor is connected to the power supply line and the other end of the retention capacitive element, and the other is connected to one of a drain and a source in the third transistor,
the other one of the drain and the source in the third transistor is connected to an anode of the organic electroluminescence element, and
a cathode of the organic electroluminescence element is set to a fixed potential.

10. A display device comprising:
a display unit having a plurality of pixels each including a light emitting element and a transistor for driving, and a scan line, a signal line, a power supply line and a gate line connected to each of the pixels;
a scan line drive circuit applying a selection pulse for sequentially selecting the plurality of pixels, to the scan line; and
a signal line drive circuit writing a video signal to a pixel selected by the scan line drive circuit by applying a video signal voltage to the signal line,
wherein the transistor for driving is disposed on a path between the power supply line and the light emitting element, in each of the pixels, and
gate voltage for correction to be applied to a back gate of the transistor for driving via the gate line is set individually in each of unit regions in the display unit.

11. An electronic device comprising a display device,
the display device comprising:
a display unit having a plurality of pixels, a scan line, a signal line, a power supply line and a gate line connected to each of the pixels, the plurality of pixels each including a light emitting element, a transistor for driving, and a transistor for correction;
a scan line drive circuit applying a selection pulse for sequentially selecting the plurality of pixels, to the scan line; and
a signal line drive circuit writing a video signal to a pixel selected by the scan line drive circuit by applying a video signal voltage to the signal line,
wherein the transistor for driving and the transistor for correction are connected to each other in series on a path between the power supply line and the light emitting element in each of the pixels, and
gate voltage for correction to be applied to the gate of the transistor for correction via the gate line is set individually in each of unit regions in the display unit.

12. An electronic device comprising a display device,
the display device comprising:
a display unit having a plurality of pixels each including a light emitting element and a transistor for driving, and a scan line, a signal line, a power supply line and a gate line connected to each of the pixels;
a scan line drive circuit applying a selection pulse for sequentially selecting the plurality of pixels, to the scan line; and
a signal line drive circuit writing a video signal to a pixel selected by the scan line drive circuit by applying a video signal voltage to the signal line,
wherein the transistor for driving is disposed on a path between the power supply line and the light emitting element, in each of the pixels, and
gate voltage for correction to be applied to a back gate of the transistor for driving via the gate line is set individually in each of unit regions in the display unit.

13. A display device comprising
a plurality of pixels each including a light emitting element, a transistor for driving, and a transistor for correction,
wherein the transistor for driving and the transistor for correction are connected to each other in series on a path between a power supply line and the light emitting element in each of the pixels, and
gate voltage for correction to be applied to the gate of the transistor for correction is set individually in each of unit regions in the display unit.

14. The display device according to claim 13, wherein at the time of light emitting operation of the light emitting element, the transistor for correction operates in a linear region.

15. A display device comprising:
a display unit having a plurality of pixels, a scan line, a signal line, a power supply line and a gate line connected to each of the pixels, the plurality of pixels each including a light emitting element, a transistor for driving, and a transistor for correction;
wherein the transistor for driving and the transistor for correction are connected to each other in series on a path between the power supply line and the light emitting element, in each of the pixels,
the gate line is disposed along the signal line, and
gate voltage for correction to be applied to a gate of the transistor for correction via the gate line is set individually in each of unit regions in the display unit.
